(19) United States
(12) Patent Application Publication
(10) Pub. No.: US 2025/0362633 A1
(43) Pub. Date: Nov. 27, 2025

(54) IMAGE FORMING SYSTEM, RECORDING MEDIUM EJECTION METHOD, AND STORAGE MEDIUM

(71) Applicant: Konica Minolta, Inc., Tokyo (JP)

(72) Inventor: Eiichi NARIMATU, Tokyo (JP)

(21) Appl. No.: 19/206,907

(22) Filed: May 13, 2025

(30) Foreign Application Priority Data
May 27, 2024 (JP) 2024-085705

(51) Int. Cl. G03G 15/00

(52) U.S. Cl. CPC G03G 15/6538; G03G 15/5062; G03G 15/55; G03G 15/6573; G03G 2215/00421; G03G 2215/00759; G03G 2215/00886

(57) ABSTRACT

An image forming system includes: an image former that forms images on a plurality of recording media; an inspector that detects a quality abnormality of at least one of the recording media on which at least one of the images is formed; and a controller that causes a recording medium on which an image identical to an image on an abnormal recording medium is formed to be ejected to a first ejector, the abnormal recording medium being a recording medium on which the quality abnormality is detected.

### CROSS REFERENCE TO RELATED APPLICATIONS

The entire disclosure of Japanese Patent Application No. 2024-085705 filed on May 27, 2024 is incorporated herein by reference in its entirety.

### BACKGROUND

### Technological Field

The present invention relates to an image forming system, a recording medium ejection method, and a storage medium.

### Description of Related Art

Conventionally, there has been known an image forming system in which an inspecting device is arranged subsequent to an image forming apparatus that forms an image on a recording medium such as a sheet. The inspection device inspects the presence or absence of a quality abnormality of a recording medium on which an image is formed. In such an image forming system, the recording medium determined to have a quality abnormality during inspection is ejected to a purge tray different from a normal sheet ejection tray, and the recording medium having the quality abnormality is printed again, so that the entire printing is continued.

For example, Japanese Patent Publication Laid-Open No. 2019-008116, discloses an image forming system in which, in a case where a quality abnormality occurs in a recording medium on which images are formed, the recording medium on which the quality abnormality has occurred and recording medium subsequent thereto are output to a purge tray. In this way, by ejecting all the recording media subsequent to the recording medium in which the quality abnormality has occurred to the purge tray, the operator can easily grasp the position of the recording medium in which the quality abnormality has occurred and the original insertion positions of the recording medium on which reprinting has been performed.

By the way, in the image forming system described in Japanese Patent Publication Laid-Open No. 2019-008116, the reprinted recording medium is also ejected to the purge tray. Therefore, although an operator can grasp the insertion position of the re-printed recording medium, the operator is required to find the target recording medium from among the recording media ejected onto the purge tray and manually re-insert the recording medium into a correct position. Therefore, such an image forming system has a problem in that, in a case where a quality abnormality occurs in the recording medium, it takes more time and effort to rearrange the order of recording media.

### SUMMARY

An object of the present invention is to provide an image forming system, a recording medium ejection method, and a recording medium capable of reducing time and effort for arranging recording media when a quality abnormality in a recording medium is detected.

In order to achieve at least one of the above-described objects, an image forming system reflecting one aspect of the present invention includes: an image former that forms images on a plurality of recording media; an inspector that detects a quality abnormality of at least one of the recording media on which at least one of the images is formed; and a hardware processor that functions as a controller causing a recording medium on which an image identical to an image on an abnormal recording medium is formed to be ejected to a first ejector, the abnormal recording medium being a recording medium in which the quality abnormality is detected.

A recording medium ejection method reflecting another aspect of the present invention includes: forming images on a plurality of recording media; detecting a quality abnormality of at least one of the recording media on which at least one of the images is formed; and causing a recording medium on which an image identical to an image on an abnormal recording medium is formed to be ejected to a first ejector, the abnormal recording medium being a recording medium in which the quality abnormality is detected.

A non-transitory computer-readable storage medium reflecting yet another aspect of the present invention stores a program for causing a computer to execute the above recording medium ejection method.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating an example of a configuration of an image forming system according to the present embodiment;

FIG. 2 is a block diagram showing a main part of a control system of the image forming system according to the present embodiment;

FIG. 3 is a functional block diagram illustrating an example of a configuration of the controller of FIG. 2;

FIG. 4 is a schematic diagram illustrating a first example of setting of an ejection destination of a sheet, and includes;

FIG. 5 is a schematic diagram illustrating a second example of setting of the ejection destination of the sheet;

FIG. 6 is a schematic diagram illustrating a third example of setting of the ejection destination of the sheet;

FIG. 7 is a schematic diagram illustrating a fourth example of setting of the ejection destination of the sheet; and

FIG. 8 is a flowchart illustrating an example of the flow of the ejection control processing according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

In the drawings, components denoted by the same reference numerals are the same or correspond to each other, and this is common throughout the entire specification.

Hereinafter, embodiments of the present disclosure will be described with reference to the drawings. An image forming system according to the present embodiment is capable of forming an image on a sheet (recording medium) such as a flat sheet. Note that hereinafter, a case where a sheet is used as a recording medium will be described as an example, but the recording medium is not limited to a sheet, and other media such as cloth may be used, for example.

### <Configuration of Image Forming System 1>

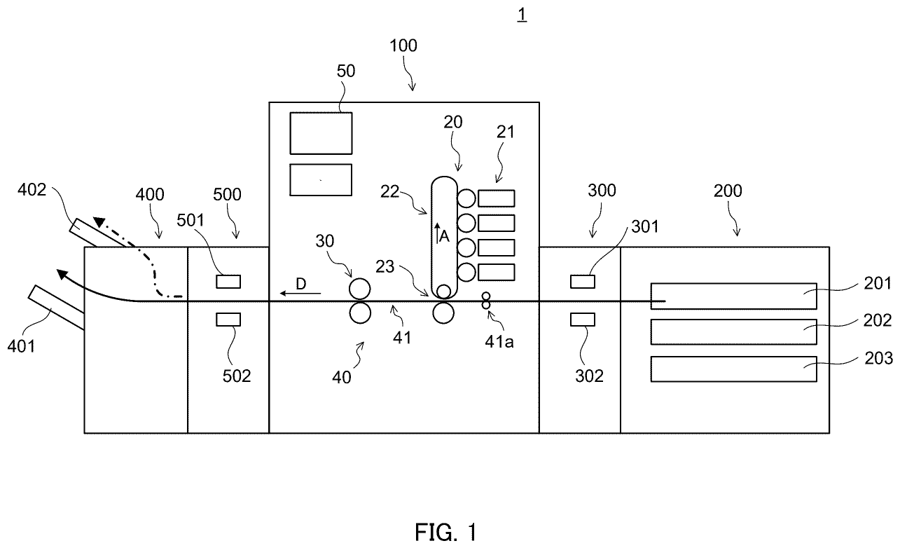

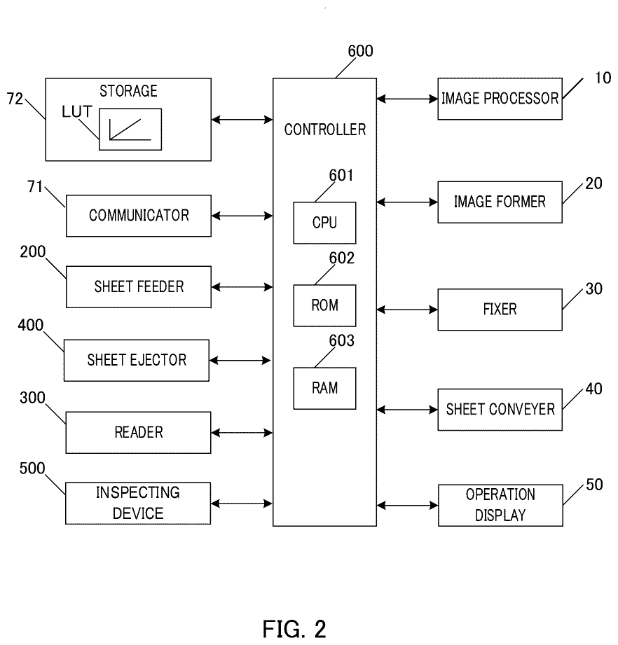

FIG. 1 is a schematic diagram illustrating an example of a configuration of an image forming system 1 according to the present embodiment. FIG. 2 is a block diagram illustrating a main part of a control system of the image forming system 1 according to the present embodiment. As illustrated in FIG. 1, the image forming system 1 is configured to include an image forming apparatus 100, a sheet feeder 200, a reader 300, an inspecting device 500, a sheet ejector 400, and the like.

The image forming apparatus 100 is an intermediate transfer system color image forming apparatus utilizing an electrophotographic process technology. That is, the image forming apparatus 100 performs primary transfer of a toner image of each of colors of CMYK formed on a photoreceptor to an intermediate transfer member, and performs secondary transfer of the toner images to a sheet after the toner images of the four colors are overlapped with each other on the intermediate transfer member, thereby forming an image. Note that CMYK refers to cyan (C), magenta (M), yellow (Y), and black (K).

The image forming apparatus 100 adopts a tandem system whereby photoreceptors corresponding to the four colors of CMYK are arranged in series in a travel direction of an intermediate transfer member, and the toner images of the respective colors are sequentially transferred onto the intermediate transfer member by a single procedure.

As shown in FIG. 2, the image forming system 1 includes an image processor 10, an image former 20, a fixer 30, a sheet conveyor 40, an operation display 50, a communicator 71, a storage 72, a controller 600, a sheet feeder 200, a reader 300, an inspecting device 500, sheet ejector 400, and the like.

The image processor 10 includes a circuit and the like that applies image processing to input image data in accordance with initial settings or user settings. The image former 20 is controlled on the basis of the image-processed image data.

The image former 20 includes image forming units 21, an intermediate transfer unit 22, and a secondary transfer unit 23. The image forming units 21 form images with color toners of the respective color components based on the image data from the image processor 10. For example, the image forming units 21 form an image with color toners of color components of Y (yellow), M (magenta), C (cyan), and K (black).

The image forming unit 21 includes, for each color, an exposure device, a developing device, a photosensitive drum, a charging device, and a drum cleaning device. As the exposure device, the developing device, the photosensitive drum, the charging device, and the drum cleaning device, known techniques can be adopted, and therefore, detailed descriptions thereof are omitted here.

The intermediate transfer unit 22 includes an intermediate transfer belt and the like. The intermediate transfer belt is stretched around a plurality of support rollers in a loop shape, and travels in a direction of an arrow A. The intermediate transfer unit 22 includes, as support rollers, rollers such as a backup roller, a primary transfer roller, and a drive roller, but these are not illustrated here. The intermediate transfer belt is pressed against the photosensitive drums, and thus the toner image is transferred from the photosensitive drums to the intermediate transfer belt.

Note that the intermediate transfer unit 22 may be configured to include a belt cleaning device having a plate-like belt cleaning blade or the like that comes into sliding contact with the surface of the intermediate transfer belt. The belt cleaning device removes transfer residual toner and the like remaining on the surface of the intermediate transfer belt after the secondary transfer.

The secondary transfer unit 23 includes a secondary transfer roller and the like. The secondary transfer roller is in pressed contact with the intermediate transfer belt. Thus, a secondary transfer nip is formed between the intermediate transfer belt and the secondary transfer roller.

In the secondary transfer unit 23, when the sheet is conveyed to the secondary transfer nip, the toner images in the respective colors carried on the intermediate transfer belt are collectively transferred onto the sheet. The sheet on which the toner image has been transferred is conveyed toward the fixer 30 by the secondary transfer roller.

Note that as the secondary transfer unit 23, instead of a roller-type secondary transfer unit including a secondary transfer roller and the like, a belt-type secondary transfer unit including a secondary transfer belt and the like stretched around a plurality of support rollers may be used.

The fixer 30 includes a fixing roller and a pressure roller. The fixing roller is heated to a predetermined fixing temperature, and the pressure roller forms a fixing nip for holding and conveying a sheet with the fixing roller. The fixer 30 applies heating and pressurizing to the conveyed sheet on which the toner image has been secondarily transferred, thereby fixing the toner image on the sheet.

The sheet conveyor 40 includes a conveyance path 41 and the like. The conveyance path 41 is composed of, for example, a path for conveying a sheet, a plurality of conveyance rollers, and a drive motor for rotation-driving these conveyance rollers. The conveyance path 41 conveys the sheet supplied from the sheet feeder 200 to the secondary transfer unit 23 and the fixer 30, and then to the sheet ejector 400.

In the conveyance path 41, a registration roller pair 41a is provided on the upstream side of the second transfer unit 23 in the sheet conveyance direction D. The registration roller pair 41a adjusts a conveyance timing and an orientation (angle) of the sheet to be conveyed to the secondary transfer unit 23.

The operation display 50 is composed of, for example, a liquid crystal display (LCD) with a touch panel and functions as a display part and an operation part. The display part displays various kinds of operation screens, a state of an image, operating situations of the respective functions, and the like in accordance with display control signals received from the controller 600. The operation part includes various kinds of operation keys such as a numeric keypad and a start key, accepts various input operation by a user, and outputs an operation signal to the controller 600.

The sheet feeder 200 is arranged on the upstream side of the image forming apparatus 100 in the sheet conveyance direction D and is connected to the image forming apparatus 100.

The sheet feeder 200 includes a plurality of sheet feed trays 201, 202, and 203. In each of the sheet feed trays 201, 202, and 203, sheets (standard sheets or special sheets) identified based on a basis weight, a size, or the like are stored for each type set in advance. The sheet feeder 200 supplies an instructed sheet to the image forming apparatus 100 side on the basis of an instruction from the image forming apparatus 100.

The reader 300 is disposed between the sheet feeder 200 and the image forming apparatus 100, is connected to the sheet feeder 200 on the upstream side in the sheet conveyance direction D, and is connected to the image forming apparatus 100 on the downstream side.

The reader 300 includes sensors 301 and 302 that read the sheet conveyed from the sheet feeder 200. The sensor 301 is arranged on an upper side of a path along which the sheet is conveyed, is arranged facing a side of the conveyed sheet, and is configured to read a side of a front surface (upper surface) of the conveyed sheet. The sensor 302 is arranged on a lower side of a path along which the sheet is conveyed, is arranged facing a side of the conveyed sheet, and is configured to read a back surface (lower surface) side of the conveyed sheet.

As the sensors 301 and 302, for example, a charge coupled device (CCD), a contact image sensor (CIS), or the like is used. In addition, as the sensors 301 and 302, a line sensor which extends over a width equal to or more than the width of the sheet (the width in the direction orthogonal to the sheet conveyance direction D), for example, a line scanner or a line sensor camera is used.

The sensors 301 and 302 acquire sheet information that is information on a sheet. The sensors 301 and 302 acquire, for example, the size (the sheet width, the sheet length, and the like) of the sheet, the sheet position, and the like as the sheet information.

Here, as an example, the reader 300 is configured to include the sensors 301 and 302 that read both surfaces (front and rear surfaces) of the sheet, but is not limited thereto, and may be configured to include only the sensor 301 that reads one surface (front surface) of the sheet, for example.

The inspecting device 500 is arranged between the image forming apparatus 100 and the sheet ejector 400 in the sheet conveyance direction D. The inspecting device 500 is connected to the image forming apparatus 100 on the upstream side and is connected to the sheet ejector 400 on the downstream side.

The inspecting device 500 inspects a state of a sheet on which an image is formed by the image forming apparatus 100. The inspecting device 500 includes sensors 501 and 502 that read the sheet conveyed from the image forming apparatus 100.

The sensor 501 is arranged on an upper side of a path along which the sheet is conveyed, is arranged facing a side of the conveyed sheet, and is configured to read a side of a front surface (upper surface) of the conveyed sheet. The sensor 502 is arranged on the lower side of the path along which the sheet is conveyed, is arranged facing the conveyed sheet side, and is configured to read the back surface (lower surface) side of the conveyed sheet.

As the sensors 501 and 502, for example, similarly to the sensors 301 and 302 of the reader 300, a CCD, a CIS, or the like is used. In addition, as the sensors 501 and 502, a line sensor which extends over a width equal to or more than the width of the sheet (the width in the direction orthogonal to the sheet conveyance direction D), for example, a line scanner or a line sensor camera is used.

The sensors 501 and 502 read the image formed on the sheet. Here, as an example, the inspecting device 500 is configured to include the sensors 501 and 502 that read both surfaces (front and rear surfaces) of the sheet, but is not limited thereto, and may be configured to include only the sensor 501 that reads one surface (front surface) of the sheet, for example.

The inspecting device 500 reads the image formed on the sheet by the sensors 501 and 502, and detects the presence or absence of quality abnormality in the sheet based on the read image. The quality abnormality is so-called “waste” and includes, for example, a failure in image formation on a sheet and a failure in sheet condition such as sheet size.

The sheet ejector 400 is disposed on the downstream side of the inspecting device 500 in the sheet conveyance direction D, and is connected to the image forming apparatus 100 via the inspecting device 500. The sheet ejector 400 includes a sheet ejection tray 401 and a purge tray 402, and ejects the conveyed sheet to the sheet ejection tray 401 or the purge tray 402.

The sheet ejection tray 401 ejects a sheet on which an image has been formed by the image forming apparatus 100. The purge tray 402 ejects, for example, a sheet for which a quality abnormality has been detected as a result of reading of the sheet by the inspecting device 500. Sheet ejection to the sheet ejection tray 401 and the purge tray 402 is controlled by the controller 600. Note that if the sheet size read by the reader 300 does not satisfy a predetermined condition, the sheet ejector 400 may eject, from the purge tray 402, a sheet on which no image has been formed by the image forming apparatus 100, as indicated by a one dot chain arrow in FIG. 1.

To the controller 600, the above-described image processor 10, image former 20, fixer 30, sheet conveyor 40, operation display 50, communicator 71, storage 72, sheet feeder 200, reader 300, inspecting device 500 and sheet ejector 400 are connected. The controller 600 gives various instructions to these units and executes predetermined processing.

The controller 600 includes a central processing unit (CPU) 601, a read only memory (ROM) 602, and a random access memory (RAM) 603. The CPU 601 reads a program corresponding to the processing content from the ROM 602, develops the program in the RAM 603, and centrally controls the operation of each block of the image forming system 1 in cooperation with the developed program. At this time, various data such as a look up table (LUT) stored in the storage 72 are referred to. The storage 72 includes, for example, a non-volatile semiconductor memory (so-called flash memory) or a hard disk drive. The CPU 601 is an example of a hardware processor that functions as the controller 600.

The controller 600 transmits/receives various types of data to/from an external device (e.g., a personal computer) connected to a communication network such as a local area network (LAN), a wide area network (WAN) via a communicator 71. The controller 600 receives, for example, image data transmitted from the external device, and forms an image on a sheet on the basis of the image data (input image data). The communicator 71 is constituted by a communication control card such as a LAN card.

In the present embodiment, when a quality abnormality occurs in a sheet on which an image has been formed, the controller 600 performs ejection control processing for controlling the ejection destination of the sheet. Details of the ejection control processing will be described later.

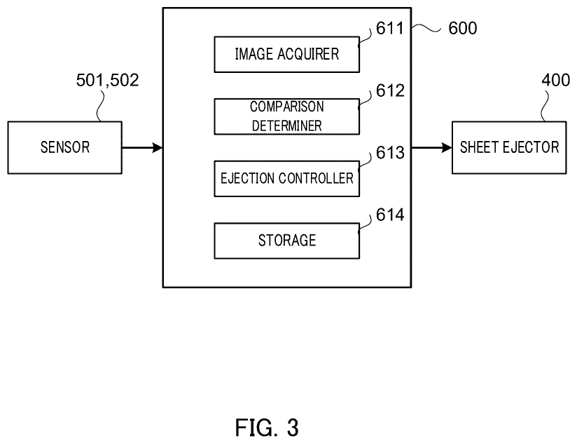

FIG. 3 is a functional block diagram showing an example of the configuration of the controller 600 in FIG. 2. As shown in FIG. 3, the controller 600 includes an image acquirer 611, a comparison determiner 612, an ejection controller 613, and a storage 614. Here, only the processing units related to the ejection control processing are illustrated.

The image acquirer 611 acquires the image formed on the sheet detected by the sensors 501 and 502 of the inspecting device 500.

In the ejection control processing, the comparison determiner 612 compares the image on the sheet in which the quality abnormality has occurred with the image formed on the sheet conveyed to the inspecting device 500. Next, the comparison determiner 612 determines, based on the comparison result, whether or not the sheet conveyed to the inspecting device 500 is a sheet corresponding to the same page as the sheet in which the quality abnormality has occurred.

The ejection controller 613 controls an ejection destination of a sheet on which an image is formed. Specifically, the ejection controller 613 switches the ejection destination so that the sheet on which the image is formed is ejected to one of the sheet ejection tray 401 and the purge tray 402. For example, in the ejection control processing, the ejection controller 613 performs control such that the sheet having the quality abnormality is ejected to the purge tray 402.

The storage 614 stores various kinds of information used in each unit of the controller 600. For example, the storage 614 stores an image formed on a sheet in which a quality abnormality has occurred. Note that the “image on the sheet in which the quality abnormality has occurred” stored at this time is not an image actually detected by the sensors 501 and 502 of the inspecting device 500 but an image to be originally formed on the sheet. Hereinafter, the image stored in this manner is described as being referred to as an “image on the sheet in which the quality abnormality has occurred”.

### <Operation of Image Forming System 1>

First, operations of the image forming system 1 according to the present embodiment having the above-described configuration will be described. In the image forming system 1, when an image is formed on a sheet which is a recording medium, the sheet is accommodated in the sheet feed trays 201, 202, and 203 of the sheet feeder 200. Next, the sheet supplied from the sheet feeder 200 is conveyed to the reader 300, where sheet information such as a sheet size is read, and then the sheet is conveyed to the image forming apparatus 100.

The sheet conveyed to the image forming apparatus 100 is subjected to image formation (hereinafter, referred to as “printing” as appropriate) in the image forming apparatus 100, and is conveyed to the inspecting device 500. The sheet conveyed to the inspecting device 500 is subjected to ejection control processing, and the presence or absence of quality abnormality in the printed sheet is inspected. Next, the sheet subjected to the inspection is conveyed to the sheet ejector 400.

The sheet conveyed to the sheet ejector 400 is ejected to either the sheet ejection tray 401 or the purge tray 402 according to the inspection result by the ejection control processing. For example, when the sheet on which the image has been formed has no abnormality in quality, the sheet is usually ejected to the sheet ejection tray 401. Further, in a case where the quality abnormality occurs on the sheet on which the image is formed, the sheet on which the quality abnormality occurs (hereinafter, appropriately referred to as “abnormal sheet”) is ejected to the purge tray 402.

Furthermore, in a case where a quality abnormality occurs in the sheet on which the image is formed, recovery, in which the sheet is re-printed, is performed. The recovery is performed, for example, in such a manner as to interrupt the current print job. Thus, the sheet reprinted corresponding to the sheet in which the quality abnormality has occurred (hereinafter, appropriately referred to as a “recovery sheet”) is printed.

By the way, in the conventional image forming system, after the abnormal sheet is ejected to the purge tray, the subsequent sheet in which the quality abnormality does not occur is ejected to the sheet ejection tray. At this time, recovery is performed by interrupting the current print job as described above. Therefore, since the recovery sheet is inserted between sheets subsequent to the abnormal sheet, it is conceivable that the recovery sheet is not inserted at a correct position.

For example, in preparing a printed product including a plurality of pages, in a case where group printing in which only a necessary number of copies are continuously printed for each page is performed, the recovery sheet may be ejected to the sheet ejection tray during printing of pages different from the page corresponding to the recovery sheet. In this case, an operator has to find the recovery sheet from the sheets ejected to the sheet ejection tray and manually reinsert the recovery sheet in a correct position, which increases time and labor of work.

In contrast, in the image forming system described in PTL 1 described in the section of the background art, after the abnormal sheet is ejected to the purge tray, the ejection destinations of the sheets are controlled so that all the sheets following the abnormal sheet are ejected to the purge tray. Thus, an operator can grasp that the first sheet ejected to the purge tray is an abnormal sheet, and can easily grasp the original insertion position of the recovery sheet.

However, in the image forming system described in PTL 1, the recovery sheet is also ejected to the purge tray. Therefore, although the operator can grasp the insertion position of the recovery sheet, the operator has to find the recovery sheet from the sheets ejected to the purge tray and manually reinsert the recovery sheet into a correct position. Therefore, even in a case where the sheet ejection is controlled as in the image forming system described in PTL 1, the time and effort for the work increase similarly to the conventional case.

Therefore, in the present embodiment, when a quality abnormality in the sheet on which the image is formed is detected, ejection control processing of controlling the ejection destination of the sheet subsequent to the abnormal sheet is performed according to position where the abnormal sheet has occurred. The ejection control processing is mainly performed during group printing.

For example, when a quality abnormality of the sheet is detected in group printing, the sheet is ejected to the purge tray 402 similarly to the conventional manner. Next, among the sheets subsequent to the abnormal sheet in which the quality abnormality has occurred, the sheet of the same page on which the same image as the sheet in which the quality abnormality has occurred is formed is ejected to the sheet ejection tray 401. Furthermore, a sheet of a different page on which an image different from the image on the sheet in which the quality abnormality has occurred is ejected to the purge tray 402.

Note that in the ejection control processing according to the present embodiment, the “image” formed on the sheet refers to all of letters, images, and the like formed on the sheet in a case where a plurality of letters, images, and the like are formed on the sheet. Therefore, the images being “the same” means that the images on the entire sheet are the same, and the “same page” means the sheet on which such the same images are formed.

Furthermore, as described above, the “image on the sheet in which the quality abnormality has occurred” does not refer to an image actually detected by the sensors 501 and 502 of the inspecting device 500 in a state in which the abnormality has occurred, but refers to an image to be originally formed on the sheet. Therefore, the image on the sheet in which the quality abnormality has occurred and the image on the predetermined sheet being “the same” or “matching” indicates that the image to be originally formed on the sheet in which the quality abnormality has occurred and the image formed on the predetermined sheet are the same or match.

By controlling the ejection of the sheet in this way, it is possible to prevent the sheets of the same page from being separated and ejected to a plurality of trays when printing a necessary number of copies of a printed product consisting of a single page even in group printing. Therefore, it is possible to reduce the time and effort for arranging the order of the sheets.

Hereinafter, the sheet ejection control according to the position of the abnormal sheet will be specifically described with reference to a first example and a second example. The first example and the second example are examples in which only four copies of a printed product composed of three pages are printed. Note that, in the first example and the second example, for ease of description, a case in which recovery when a quality abnormality occurs is not considered will be described. Furthermore, in the following example, as initial setting of the ejection destination of the sheet, it is assumed that the sheet on which the image is formed is set to be ejected to the sheet ejection tray 401 and the sheet on which the quality abnormality is detected is set to be ejected to the purge tray 402.

### First Example

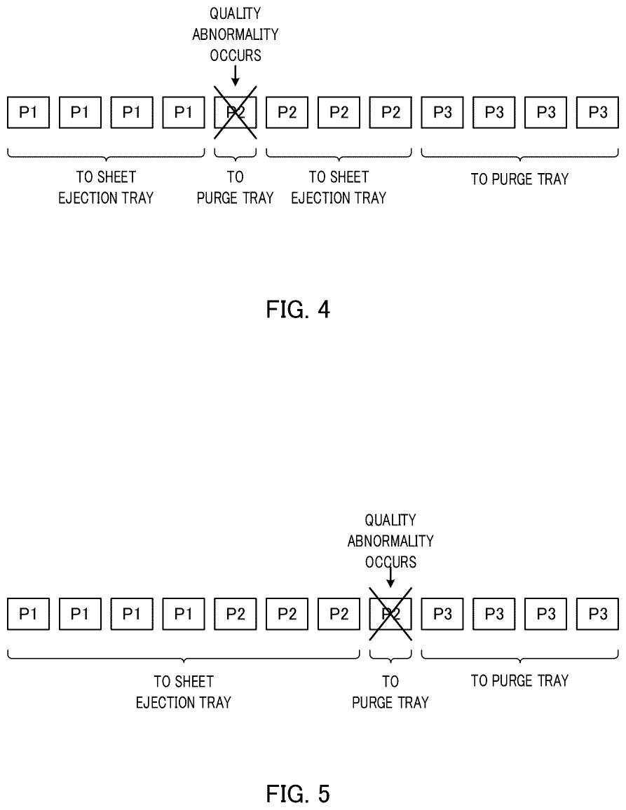

FIG. 4 is a schematic diagram illustrating a first example of setting of an ejection destination of a sheet. The first example is an example of a case where a quality abnormality has occurred in the first or middle sheet of the same page during group printing. More specifically, the first example is an example in which a quality abnormality has occurred in the first or middle sheet of the second page, and FIG. 4 illustrates a case in which a quality abnormality has occurred in the first sheet of the second page.

FIG. 4 illustrates the order of printing when group printing is performed. In FIG. 4, “P1,” “P2,” and “P3” indicate the sheets of the first page, the second page, and the third page, respectively. Note that an order of such printing and the notation of pages are also the same in second to fourth examples described later with reference to FIGS. 5 to 7.

First, as shown in FIG. 4, the four sheets of the first page P1 are ejected to the sheet ejection tray 401 in accordance with the initial setting. When a quality abnormality occurs in the first sheet of the second page P2 after the first page P1 is ejected, the sheet is ejected to the purge tray 402.

Further, the same image as that of the sheet in which the quality abnormality has occurred is formed on three sheets of the second page P2 subsequent to the sheet in which the quality abnormality has occurred. Therefore, the three sheets of the second page P2 are ejected to the sheet ejection tray 401.

On the other hand, the sheet following the sheet of the second page P2 is the sheet of the third page P3. An image different from the image on the sheet in which the quality abnormality has occurred is formed on the sheet of the third page P3. Therefore, the four sheets of the third page P3 are ejected to the purge tray 402. This is for enabling an operator to grasp the position of the sheet (second page) in which the quality abnormality has occurred.

As illustrated in the first example, when the quality abnormality occurs in the first sheet of the same page, the sheet on which the same image as the image on the sheet in which the quality abnormality has occurred is formed is ejected to the sheet ejection tray 401. Furthermore, all the subsequent sheets of pages on which different images are formed are ejected to the purge tray 402. The same applies to a case where the quality abnormality occurs in a middle sheet of the same page. Thus, the operator can grasp the position of the sheet in which the quality abnormality has occurred, and the time and effort of the operator in arranging the sheets can be reduced.

### Second Example

FIG. 5 is a schematic diagram illustrating a second example of setting of an ejection destination of a sheet. The second example is an example of a case where a quality abnormality has occurred in the last sheet of the same page during group printing. More specifically, the second example is an example of a case where a quality abnormality has occurred in the last sheet of the second page P2.

First, as shown in FIG. 5, the four sheets of the first page P1 are ejected to the sheet ejection tray 401 in accordance with the initial setting. Three sheets of the second page P2 before the quality abnormality occurs are also ejected to the sheet ejection tray 401. When the quality abnormality occurs in the last sheet of the second page P2, the sheet is ejected to the purge tray 402.

Next, the sheet subsequent to the sheet in which the quality abnormality has occurred is the sheet of the third page P3. An image different from the image on the sheet in which the quality abnormality has occurred is formed on the sheet of the third page P3. Therefore, the four sheets of the third page P3 subsequent to the sheet in which the quality abnormality has occurred are ejected to the purge tray 402 as in the first example.

As shown in the second example, when the quality abnormality occurs in the last sheet of the same page, all sheets of the subsequent pages on which different images are formed are ejected to the purge tray 402. As a result, similarly to the first example, the operator can grasp the position of the sheet in which the quality abnormality has occurred, and the time and labor of the operator in arranging the sheets can be reduced.

As described above, as illustrated in the first example and the second example, in the present embodiment, the abnormal sheet is ejected to the purge tray 402, and the remaining sheets of the same page as the abnormal sheet are ejected to the sheet ejection tray 401. Sheets subsequent to the sheets of the same page as the abnormal sheet is ejected to the purge tray 402. Thus, the operator can easily grasp the position of the sheet where the quality abnormality has been detected.

### (Recovery for Abnormal Sheet)

On the other hand, when the recovery for the abnormal sheet is considered, in the ejection control processing according to the present embodiment, the ejection destination of the subsequent sheet is further controlled according to the insertion position of the recovery sheet.

Hereinafter, the ejection control of the sheet according to the position where the recovery sheet is inserted will be specifically described with reference to a third example and a fourth example. Similarly to the first example and the second example described above, the third example and the fourth example are examples in which only four copies of a printed product composed of three pages are printed.

### Third Example

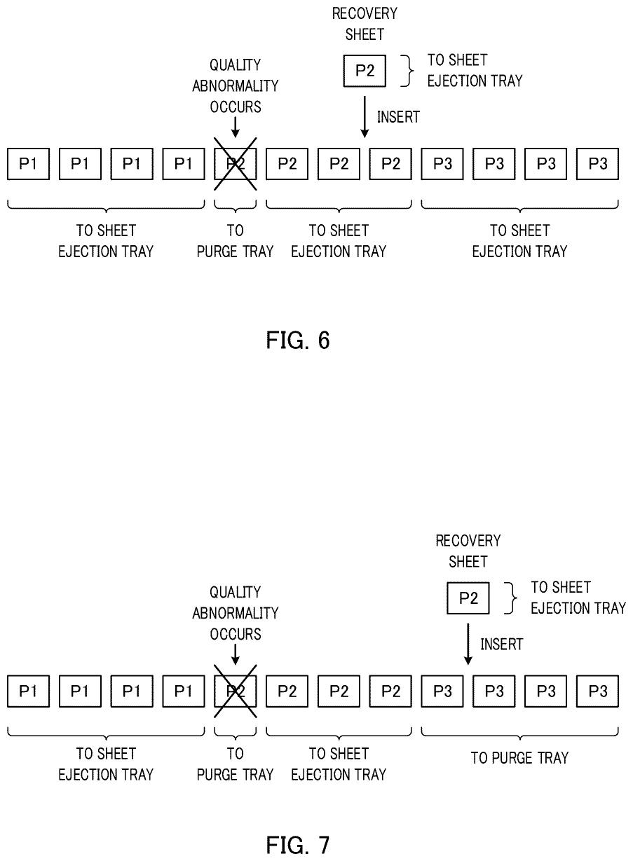

FIG. 6 is a schematic diagram illustrating a third example of setting of an ejection destination of a sheet. The third example is an example of a case where, in group printing, a recovery sheet is inserted during printing of the same page as a sheet on which a quality abnormality has occurred. More specifically, the third example is an example of a case where the quality abnormality occurs in the sheet of the second page P2 and the recovery sheet is inserted during the printing of the remaining second page P2.

First, as shown in FIG. 6, the four sheets of the first page P1 are ejected to the sheet ejection tray 401 in accordance with the initial setting. When a quality abnormality occurs in the first sheet of the second page P2 after the first page P1 is ejected, the sheet is ejected to the purge tray 402. Further, the same image as that of the sheet in which the quality abnormality has occurred is formed on three sheets of the second page P2 subsequent to the sheet in which the quality abnormality has occurred. Therefore, the three sheets of the second page P2 are ejected to the sheet ejection tray 401.

Here, when the re-printed recovery sheet is inserted while the remaining sheets of the second page P2 are printed, the inserted recovery sheet is ejected to the sheet ejection tray 401. Thus, the number of copies of the second page P2 to be printed is complete on the sheet ejection tray 401. Therefore, since the operator does not needs to grasp the position of the sheet where the quality abnormality has occurred, the subsequent sheets of the third page P3 is ejected not to the purge tray 402 but to the sheet ejection tray 401.

As illustrated in the third example, the recovery sheet for the abnormal sheet is inserted while the page corresponding to the abnormal sheet is printed, and thus it is possible to continuously eject the required number of copies of the page. Therefore, it is not necessary to eject the subsequent sheets to the purge tray 402, and the subsequent sheets can be ejected to the sheet ejection tray 401. Therefore, it is possible to reduce the time and effort of the operator when arranging the sheets.

### Fourth Example

FIG. 7 is a schematic diagram illustrating a fourth example of setting of an ejection destination of a sheet. The fourth example is an example of a case where, in group printing, a recovery sheet is inserted during printing of a page different from a page of a sheet on which a quality abnormality has occurred. To be more specific, the fourth example is an example in which a quality abnormality has occurred in the sheet of the second page P2, and a recovery sheet is inserted during printing of the third page P3 different from the page of the sheet in which the quality abnormality has occurred. FIG. 7 illustrates a case where a recovery sheet is inserted between the first sheet and the second sheet on the third page P2.

First, as shown in FIG. 7, the four sheets of the first page P1 are ejected to the sheet ejection tray 401 in accordance with the initial setting. When a quality abnormality occurs in the first sheet of the second page P2 after the first page P1 is ejected, the sheet is ejected to the purge tray 402. Further, the same image as that of the sheet in which the quality abnormality has occurred is formed on three sheets of the second page P2 subsequent to the sheet in which the quality abnormality has occurred. Therefore, the three sheets of the second page P2 are ejected to the sheet ejection tray 401.

Next, the first sheet of the third page P3 is ejected to the purge tray 402. When the first sheet of the third page P3 is ejected, the recovery sheet of the second page P2 is inserted and ejected to the sheet ejection tray 401. Thereafter, the remaining three sheets of the third page P3 are ejected to the purge tray 402.

As shown in the fourth example, when the recovery sheet for the abnormal sheet is inserted while the page different from the page corresponding to the abnormal sheet is printed, the sheet corresponding to the page different from the page corresponding to the abnormal sheet is ejected to the purge tray 402. Thus, the operator can easily grasp the position of the sheet where the quality abnormality has been detected.

From the above, as shown in the third example and the fourth example, in the present embodiment, when a recovery sheet for an abnormal sheet is inserted during printing of the same page, all the remaining sheets subsequent to the recovery sheet are ejected to the sheet ejection tray 401. Furthermore, when a recovery sheet for an abnormal sheet is inserted during printing of a different page, all the remaining sheets following the recovery sheet are ejected to the purge tray 402.

In this way, the ejection destination of the sheet of the page different from the page to which the recovery sheet corresponds is controlled according to the insertion position of the recovery sheet, and thus it is possible to prevent the recovery sheet from being mixed with the sheets of the different page and the time and effort required for the operator to arrange the sheets from increasing.

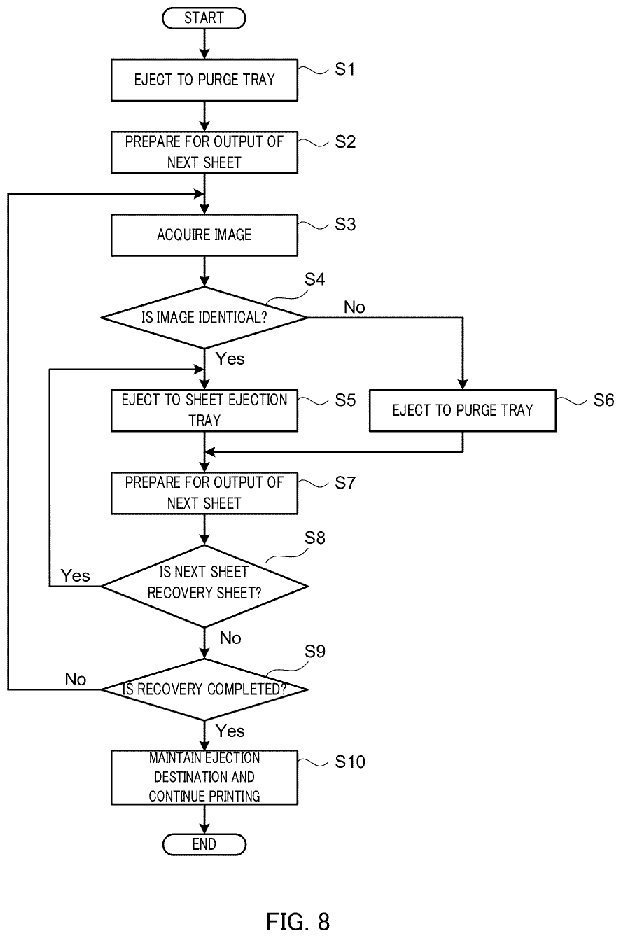

FIG. 8 is a flowchart illustrating an example of the flow of ejection control processing according to the present embodiment. In the flowchart shown in FIG. 8, processing by each unit of the controller 600 is shown. Furthermore, the ejection control processing is applied when group printing is performed.

The ejection control processing is performed in a case where quality abnormality of the sheet on which the image is formed occurs. At this time, the image formed on the sheet having the quality abnormality and detected by the sensors 501 and 502 of the inspecting device 500 is stored in the storage 614.

When the ejection control processing is started, first, in step S1, the ejection controller 613 of the controller 600 performs control so that the sheet having the quality abnormality is ejected to the purge tray 402.

In step S2, the controller 600 prepares for output of the next sheet based on the contents of the print job. In step S3, the image acquirer 611 acquires the image formed on the sheet conveyed to the inspecting device 500 from the sensors 501 and 502 of the inspecting device 500.

In step S4, the comparison determiner 612 reads the image formed on the sheet in which the quality abnormality has occurred from the storage 614. Then, the comparison determiner 612 compares the image read from the storage 614 with the image acquired in step S3, and determines whether or not the two images match.

As a result of the comparison, when the two images coincide with each other (step S4: Yes), it is determined that the sheet is a sheet of the same page as the sheet in which the abnormality has occurred. Then, in step S5, the ejection controller 613 controls to eject the sheet conveyed to the inspecting device 500 to the sheet ejection tray 401. On the other hand, when the two images do not match (step S4: No), it is determined that the sheet is a sheet of a page different from the page of the sheet in which the quality abnormality has occurred. Then, in step S6, the ejection controller 613 controls the sheet conveyed to the inspecting device 500 to be ejected to the purge tray 402.

Next, in step S7, the controller 600 prepares for output of the next sheet based on the contents of the print job. In step S8, the controller 600 determines whether or not the output of the next sheet is a recovery sheet.

When the next sheet is a recovery sheet (step S8: Yes), the process proceeds to step S5, and the recovery sheet is ejected to the sheet ejection tray 401. When the next sheet is not a recovery sheet (step S8: No), the process proceeds to step S9.

In step S9, the controller 600 determines whether the recovery of the sheet having the quality abnormality is completed. When the recovery is completed (step S9: Yes), the processing proceeds to step S10. Furthermore, when the recovery is not completed (step S9: No), the process returns to step S3.

In step S10, the controller 600 maintains the tray currently set as the ejection destination of the sheet, and continues printing thereafter. That is, in step S5, when the sheet ejection tray 401 is set as the ejection destination of the sheet, the ejection destination of subsequent sheet is the sheet ejection tray 401. In addition, in a case where the purge tray 402 is set as the ejection destination of the sheet in Step S6, the ejection destination of the subsequent sheet is the purge tray 402.

As described above, in the image forming system 1 according to the present embodiment, the sheet on which the same image as the image of the abnormal sheet is formed is ejected to the sheet ejection tray 401. As a result, the operator can easily grasp the position of the abnormal sheet, and thus the time and labor required for the operator to arrange the sheets can be reduced.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming system, comprising:
an image former that forms images on a plurality of recording media;
an inspector that detects a quality abnormality of at least one of the recording media on which at least one of the images is formed; and
a hardware processor that functions as a controller causing a recording medium on which an image identical to an image on an abnormal recording medium is formed to be ejected to a first ejector, the abnormal recording medium being a recording medium in which the quality abnormality is detected.

2. The image forming system according to claim 1, wherein
in a case where at least one of the recording media on which at least one of the images is formed is ejected to the first ejector and the abnormal recording medium is ejected to the second ejector,
the controller causes, when an image on a recording medium following the abnormal recording medium is identical to the image on the abnormal recording medium, the following recording medium to be ejected to the first ejector, and
the controller causes, when the image on the following recording medium is different from the image on the abnormal recording medium, the following recording medium to be ejected to the second ejector.

3. The image forming system according to claim 1, wherein
the controller causes a recovery recording medium that is a reprint of the abnormal recording medium to be ejected to the first ejector.

4. The image forming system according to claim 3, wherein
the controller causes a recording medium following the abnormal recording medium to be ejected to either the first ejector or the second ejector according to an insertion position of the recovery recording medium.

5. The image forming system according to claim 4, wherein
the controller
causes a recording medium following the recovery recording medium to be ejected to the first ejector when the recovery recording medium is inserted after a recording medium on which an image identical to an image on the recovery recording medium is formed, and
causes the recording medium following the recovery recording medium to be ejected to the second ejector when the recovery recording medium is inserted after a recording medium on which an image different from the image on the recovery recording medium is formed.

6. The image forming system according to claim 1, wherein
the controller stops, when an image on a recording medium following the abnormal recording medium is different from the image on the abnormal recording medium, forming the image.

7. A recording medium ejection method, comprising:
forming images on a plurality of recording media;
detecting a quality abnormality of at least one of the recording media on which at least one of the images is formed; and
causing a recording medium on which an image identical to an image on an abnormal recording medium is formed to be ejected to a first ejector, the abnormal recording medium being a recording medium in which the quality abnormality is detected.

8. A non-transitory computer-readable storage medium storing a program for causing a computer to execute the recording medium ejection method according to claim 7.
